(19) United States
(12) Patent Application Publication
(10) Pub. No.: US 2001/0012546 A1
(43) Pub. Date: Aug. 9, 2001

(54) Body ornament

(76) Inventor: Manfred Braun, Hattersheim (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 09/741,758

(22) Filed: Dec. 19, 2000

(30) Foreign Application Priority Data
Dec. 21, 1999 (DE) 29922534.8

(51) Int. Cl. B32B 7/06

(52) U.S. Cl. 428/34.1; 428/40.1

(57) ABSTRACT

A body ornament whose carrier has one side provided with a skin compatible adhesive allowing the carrier to be affixed to the skin of an individual while a hologram is affixed on the other side. The adhesive can be on the hologram directly and the hologram can be applied to a finger nail or toe nail.

### FIELD OF THE INVENTION

The present invention relates to a body ornament for detachable attachment to human skin or finger or toe nails. More particularly, the invention relates to a body ornament including a hologram.

### BACKGROUND OF THE INVENTION

While various body ornaments have been utilized throughout the ages to alter the appearance of human skin and various body parts, significant among them are so-called ornamental tattoos or decals in which a design, pattern or image has been applied on a carrier to the skin. In such substances, the design is formed as a transfer pattern on the side of a paper carrier or the like which, when wetted, can transfer the image to the skin. The image itself is here directly on the skin and can be removed therefrom. Such systems have the advantage over direct tattooing in that the image or ornamental design is not permanent but can remain, frequently for relatively long periods, especially if no attempt is made to remove it.

### OBJECT OF THE INVENTION

It is the principal object of the present invention to provide an improved body ornament which has the advantages of the transfer tattoos or decals mentioned previously but also can impart special effects to the image.

Another object of the invention is to provide a unique ornamentation of body parts without permanent alteration of the skin.

Still another object of the invention is to provide a body ornament which is easily applied, has a unique appearance and can be easily removed from the skin of the wearer.

### SUMMARY OF THE INVENTION

These objects and others which will become apparent hereinafter are attained, in accordance with the invention, by providing a body ornament in which a carrier foil is adhesively applicable to the skin so that it can easily be applied thereto and removed therefrom and even reused by application to the skin and which, on its side turned away from the skin is formed with a hologram. Any kind of small hologram can be used.

The adhesive which applies the foil to the skin should be a skin compatible adhesive which is hypoallergenic with respect to the skin and can be any of the adhesive commonly used for applying medical articles such as bandages to the skin. Such adhesives enable the body ornament to be removed and reapplied to the skin several times without the danger that the ornament itself will fall off or be lost.

The fact that the body ornament has a hologram on its visible side insures that the ornament will have unique optical effects since such holograms, when they catch the light, frequently change in appearance and with respect to the visible patterns, depending upon the angle of incidence of the light, the nature of the light and the angle at which the viewer sees the image.

The ornament is especially effective in discotheques or the like in which the light source generally rotates or otherwise plays across the participants in the activity, although such holograms are also visible and provide unique effects in normal daylight, indoors or outdoors.

The carrier, according to the invention is preferably a foil of a synthetic resin material or metal or both, the combination of such materials providing an additional decorative effect apart from that provided by the hologram.

It has been found to be advantageous to make the foil completely or at least partly transparent so that the skin beneath the foil is visible. The foil then is practically invisible on the surface and the hologram itself appears to hover alone on the skin.

This effect can be obtained as well by coloring the carrier foil so that it corresponds to the color of the skin to which it is to be applied.

Advantageously, the hologram is replaceably mounted on the foil so that, if one wishes to change the decorative effect, one need not remove the foil from the skin but can substitute a different hologram. The foil can be, if desired, scented so that the scent is released slowly over time and as a function of the body temperature, thereby insuring a long life of the perfume in the foil.

The ornament can, if desired, be provided on a perfume bottle, which may hold a sample of the perfume, as a merchandising feature for the perfume and may be removed from the bottle for application to the body.

Instead of applying the hologram to the skin directly or indirectly as noted, the hologram can be applied directly or indirectly to a finger nail or toe nail.

### BRIEF DESCRIPTION OF THE DRAWING

The above and other objects, features, and advantages will become more readily apparent from the following description, reference being made to the accompanying drawing in which:

FIG. 1 is a diagram showing a portion of a human body provided with body ornaments according to the invention;

FIG. 2 is a cross sectional view through the body ornament;

FIG. 3 is a perspective view of a perfume bottle provided with the ornament before it is applied to the body;

FIG. 4 is an illustration of the application of the hologram to a finger nail; and

FIG. 5 is a perspective view of an artificial nail formed by a hologram and its adhesive layer.

### SPECIFIC DESCRIPTION

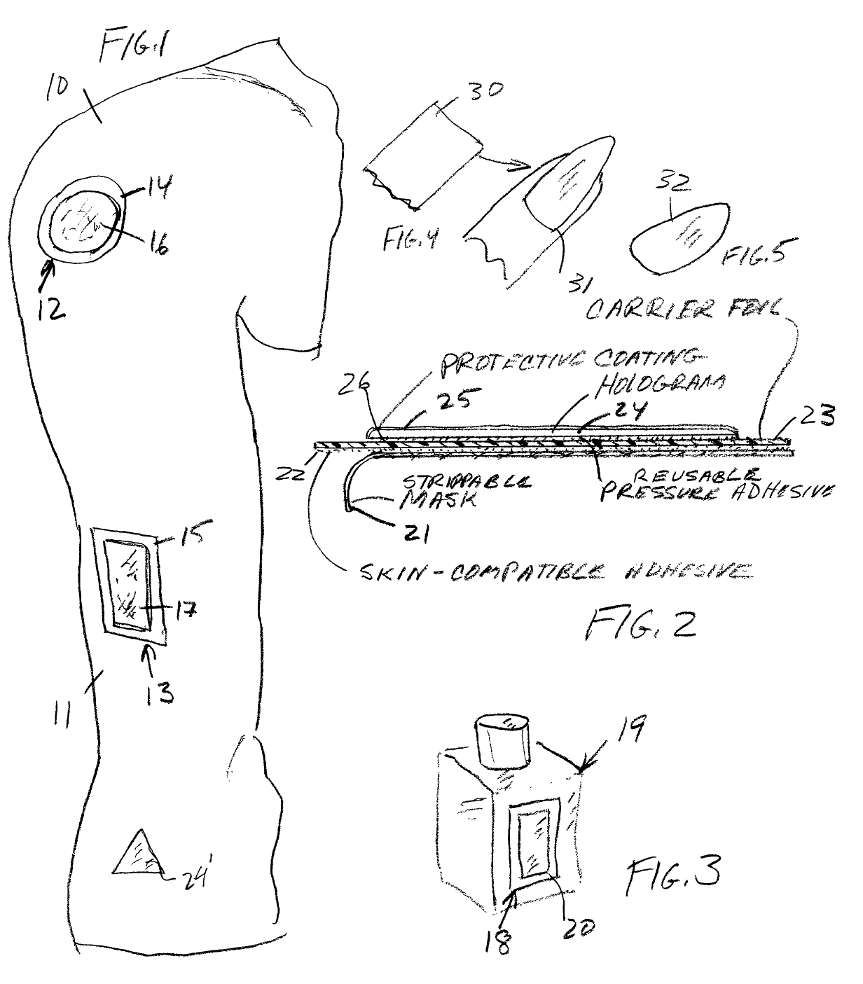

In FIG. 1, I have shown a portion of the human body, for example, the shoulder 10 and the upper arm 11 of a person, each of which has been provided with a body ornament 12 or 13 which is constructed as will be described with respect to FIG. 2 to include a carrier foil 14 or 15 and a hologram 16 or 17. The carrier foil 14 or 15 may be skin color or transparent so as to be practically invisible when applied to the skin. The hologram may have any desired pattern when visible in daylight or in monochromatic light as may play across the hologram in a discotheque or the like.

The body ornament as shown in FIG. 3 at 18 may be mounted by its reusable skin compatible adhesive on a perfume bottle 19 and, in that case, the carrier 20 can be composed of a bibulous material which has been impregnated by a sample of the perfume contained within the bottle. The user can strip the ornament 18 from the bottle 19 and apply it to the skin. The hologram 24′ can be used without a supporting foil or layer since the hologram can have an adhesive back directly.

If the ornament is not applied to a bottle when it reaches the user, it can be provided with a strippable mask 21 of silicon-coated paper which can cover the skin compatible and reusable adhesive 22 on one face of the carrier foil 23. This hologram alone can also be applied to the skin for a single use only. In this case basic foil 23 will be stripped too. The latter may be composed of a synthetic resin and/or metal. Any kind of small hologram 24 covered by a protective coating 25 or not can be applied by a reusable pressure adhesive 26 to the other side of the carrier 23.

The reusable pressure adhesive 26 allows the hologram to be removed from the carrier 23 and replaced by another hologram while the carrier foil 23 remains in place on the skin of the wearer.

FIG. 4 shows that a hologram 30, which may be rectangular and oversize, can be applied to a finger nail 31 or a toe nail and then trimmed to size to form an artificial nail adhered by the adhesive directly on the hologram to the nail. Of course, the hologram 32 (FIG. 5) can be formed originally as an artificial nail and can be applied like a conventional artificial nail. In both cases, nail polish can be applied.

I claim:

1. A body ornament comprising:
a carrier having opposite sides;
a layer of a skin-compatible adhesive on one of said sides enabling the ornament to be adhered to the skin of an individual; and
a hologram on the other of said sides.

2. The body ornament defined in claim 1 wherein said carrier is a foil.

3. The body ornament defined in claim 2 wherein said foil is composed of a synthetic resin or metal.

4. The body ornament defined in claim 2 wherein said foil is at least partially transparent.

5. The body ornament defined in claim 2 wherein said foil has substantially a human-skin color.

6. The body ornament defined in claim 2, further comprising means for securing said hologram interchangeably to said carrier.

7. The body ornament defined in claim 2 wherein said foil is scented.

8. The body ornament defined in claim 7 wherein said foil is composed at least in part of a bibulous material impregnated with a perfume.

9. The body ornament defined in claim 1 wherein said hologram is formed in a plastic or metallic foil provided directly with said adhesion.

10. The body ornament defined in claim 1 wherein said skin-compatible adhesive adheres said ornament to a surface of a perfume bottle.

11. The body ornament defined in claim 10 wherein said foil is scented.

12. The body ornament defined in claim 11 wherein said foil is composed at least in part of a bibulous material impregnated with the same perfume as is contained in said bottle.

13. A perfume package comprising:
a perfume bottle; and
a body ornament detachably mounted on said bottle, said body ornament comprising:
a carrier having opposite sides,
a layer of a skin-compatible adhesive on one of said sides enabling the ornament to be adhered to the skin of an individual, and
a hologram on the other of said sides.

14. The perfume package defined in claim 13 wherein said carrier is impregnated with a sample of the perfume in said bottle.

15. A perfume package comprising:
a perfume bottle; and
an ornament mounted on said bottle, said ornament comprising:
a carrier having opposite sides,
a layer of an adhesive on one of said sides, and
a hologram on the other of said sides.

16. The perfume package defined in claim 15 wherein said carrier is impregnated with a sample of the perfume in said bottle.

17. A finger or toe nail ornament comprising a hologram and an adhesive on said hologram for affixing said hologram to a finger or toe nail.

18. The ornament defined in claim 17 wherein said hologram is larger than the nail to which it is affixed and is trimmed to fit the nail.

19. The ornament defined in claim 17 wherein the hologram has a shape corresponding to that of the finger nail or toe nail.

20. The ornament defined in claim 17 wherein said hologram is secured to said toe nail or finger nail.
